(19) United States
(12) Patent Application Publication
(10) Pub. No.: US 2018/0018409 A1
(43) Pub. Date: Jan. 18, 2018

(54) MULTI-COMPONENT METHOD OF REAL-TIME COLLABORATION FOR THE PURPOSE OF CREATING AND NEGOTIATING A COMMON OBJECTIVE PLAN

(71) Applicant: Michael H. Peters, Knoxville, TN (US)

(72) Inventor: Michael H. Peters, Knoxville, TN (US)

(21) Appl. No.: 15/653,266

(22) Filed: Jul. 18, 2017

Related U.S. Application Data
(60) Provisional application No. 62/363,389, filed on Jul. 18, 2016.

(51) Int. Cl. G06F 17/50; G06F 17/30; G06Q 40/08; G06T 11/20; G06Q 10/10; H04L 12/24

(52) U.S. Cl. CPC G06F 17/5004; G06T 11/206; G06Q 10/10; G06F 17/30241; G06Q 40/08; H04L 41/12; H04L 41/22

(57) ABSTRACT

A multi-component method of real-time collaboration for the purpose of creating and negotiating a common object plan by mitigating and overcoming the barriers created by negative neurological hormones while facilitating the release of positive hormones throughout each phase of the method.

### CROSS RELATED REFERENCES

This application claims priority to the Provisional Patent Application No. 62/363,389 filed on Jul. 18, 2016, the entire disclosure of which is hereby incorporated herein by reference.

### BACKGROUND

The present invention pertains to a system and method relating to collaborative communication for the purpose of creating and negotiating a common objective plan by mitigating and overcoming barriers created by negative neurological hormones while facilitating the release of positive hormones throughout each phase of the method.

Collaboration is the process of two or more people or organizations working together to realize shared goals. Collaboration is very similar to cooperation, and both are opposite of competition. Generally, teams that work collaboratively can obtain greater resource, recognition and reward when facing competition for finite resources.

Structured methods of collaboration encourage introspection of behavior and communication. These methods specifically aim to increase the success of teams as they engage in collaborative problem solving. Forms, rubrics, charts and graphs are useful in these situations to objectively document personal traits with the goal of improving performance in current and future projects.

However, when collaborative groups are formed in order to achieve an objective or to make a change as the world stands, interested members within the group tend to disagree from the outset, primarily due to barriers influenced and created by negative neurological hormones. Generally, group members typically come from different backgrounds, embrace alternative beliefs, and view the world much differently from one another; namely, have different views and interests on how or if a change or outcome should be effected or achieved. This provides a diverse and sometimes hostile collaborative environment which is not ideal for an efficient resolution of change that everyone can cooperatively agree on.

In the real world, this lack of cooperation between members of a group addressing a change within their environment can be defined as a tribe of NIMBY, “Not in MY Back Yard.” The members have varied motives of fear, or pride, or greed, or resentment, or even revenge and others, lying in wait for public opportunity to denigrate any project, or product, or substantive change in their environment. It is believed and experienced that the vast majority of those who employ NIMBY tactics to harm people and projects are NOT amongst those who “just like to watch the world burn.” Most NIMBY type people employ the tactics of “We've never done it that way before” and “The old is better” and “Their motives are suspect so they must be opposed and crushed” are not hostile, but distressed. It is important to note that making people more important than projects is the baseline for collaboration and penetration into the future with grace and creativity, drawing on all resources available to achieve the best possible results. Effective collaboration is not a “necessary evil” or window dressing, but the key to the best possible future result.

It can be proposed that eliminating the NIMBY type attitude amongst collaborative group individual throughout the United States could boost the US GDP by $1.6 Trillion.

The present invention provides a collaborative system and method for drastically improving the efficiency of collaborating, overcoming the NIMBY type mindset towards change—overcoming barriers created by the release of negative neurological hormones. The difficulties inherent in the art are therefore overcome in a way which is useful, together, and efficient—which provide better and more advantageous results.

### SUMMARY

For the foregoing reasons, what is needed is to provide a multi-component method of real-time collaboration for the purpose of creating and negotiating a plan in order to carry out a project or change. In particular, a method designed to uniquely assist and encourage group collaboration within charrettes, group presentations, negotiations, and solicitations to government, community, investors, and teams, for the purpose of creating and overcoming irrational objections to a project—commonly referred to, in virtually every industry, as “NIMBY”—“Not in my back yard.”

The inventive method utilizes both tactile technology, and the science of neurology to secure necessary chemical assistance of oxytocin, dopamine, and serotonin, while subduing adrenaline, cortisol, and other destructive negative neurological hormones throughout each phase of the method. The inventive method, utilized in conjunction with tactile technology influences, changes, and encourages positive thought patterns and outcomes, dramatically overcoming the NIMBY mindset amongst group collaborators by mitigating and overcoming barriers created by negative neurological hormones while encouraging the release of positive hormones throughout each phase of the method.

Generally speaking, the multi-component method utilizes the following method of real-time collaboration for the purpose of creating and negotiating a common objective plan by mitigating and overcoming barriers created by negative neurological hormones while encouraging the release of positive hormones throughout each phase, comprising the steps of: (a) identifying a project which will bring about change and affect a plurality of different interested parties and/or organizations, (b) identifying interested parties that may be affected by the project and resulting change; (c) inviting all interested parties to meet together at a first collaborative meeting in order to collaborate and discuss details about the proposed project; (d) providing a common collaborative space for meeting that is favorable for discussion; (e) meeting together as a group all interested parties and special-interest groups at the common collaborative space; (f) providing at the common collaborative space, an apparatus for displaying a user interface, the apparatus comprising a processor, and a computer storage medium storing program instructions, which when executed by the processor cause the processor to generate a user interface, the user interface comprising: (i) a visual graphical canvas; and (ii) a palette of potential project variables which can be graphically selected and chosen via drag-and-drop from the palette to the visual graphical canvas in order to provide the parties a potential visual graphical solution and implications of said variables; (g) providing an introduction of all interested parties and special-interest groups and objectives of the project, informing all interested parties that together the parties will start with a blank canvas and as a whole make objective decisions about the project variables that will benefit the entire group in order to accomplish and adopt an overall common project plan, thereby allowing the group as a whole to take ownership of the project, participate, and cooperate encouraging the release of positive neurological homrones; (h) selecting by drag-and-drop one or more proposed project variables onto the visual graphical canvas in order to visually and graphically show one or more proposed project plans, each comprising a unique arrangements of project variables; (i) collaborating and discussing as a group each of the proposed project plans as visually displayed by the user interface in order for the group to collaborate and discuss which project plan is most beneficial to the group as a whole; and (j) making a final determination of a final project plan as decided by the group as whole, if a final determination of a final project plan cannot be decided by the group as a whole, the process returns to the step of (h) selecting drag-and-drop one or more proposed project variables on to the visual graphical canvas in order to visually and graphically show one or more proposed project plans until a final determination of a final project plan is made.

In a version of the invention, the multi-component method may comprise three primary phases. In the version, the first phase is a discovery phase for identifying a proposed project or change, identifying parties involved, communicating with parties, and inviting them to collaborate and discuss details of the project of change. Next, there is a collaborative meeting phase which is the core of the inventive method. The collaborative phase generally comprises a meeting of all interested parties, providing a visual graphical canvas, providing a palette of visual graphical variables, and commencing party collaboration resulting in a project plan which all parties agree upon. Finally, an analysis phase is introduced in order to analyze the financial feasibility of the proposed project plan and provide a follow up meeting of all parties to summarize the conclusion of the feasibility analysis of the agreed upon variables of the proposed project plan.

In a version of the discovery phase, the discovery phase comprises the steps of: (i) identifying a project which will bring about change and affect a plurality of different interested parties and/or organizations; (ii) identifying interested parties that may be affected by the project and resulting change; (iii) communicating individually to each interested party distilling how they may be affected by the proposed project, introducing proposals of the project, and creating an overall interest in further collaborating about the project; (iv) categorizing each interested party into a distinct special-interest group; and (v) inviting interested parties to meet within each of their special-interest groups in order to collaborate about the project and how it may affect their interests.

In a version of the analysis phase, the analysis phase comprises the steps of: (i) analyzing the feasibility of the final proposed project plan; (ii) meeting of all interested parties in order to present and summarize the conclusion of the feasibility analysis; and (iii) if the proposed project plan is determined as not feasible, the process returns to the collaborative meeting phase until a feasibly proposed project plan is obtained.

These and other features of the present invention will become readily apparent upon further review of the following specification and drawings.

### BRIEF DESCRIPTION OF THE DRAWINGS

These and other features, aspects, and advantages of the present invention will become better understood with regard to the following description, appended claims, and accompanying drawings where:

FIG. 1 is a flow chart of a version of the overall process in accordance with the application;

FIG. 2 is a block diagram illustrating a computer processing system in components in accordance with an element of the invention;

FIG. 3A is an example display screen shot illustrating a blank canvas and drag-and-drop variables to select from;

FIG. 3B is an example display screen shot illustrating variables placed on the visual graphical canvas via drag-and-drop from a palette of variables:

FIG. 4 is a flow chart of the discovery phase as shown in FIG. 1 in accordance with the invention;

FIG. 5A and FIG. 5B is a flow chart of the collaborative meeting phase as shown in FIG. 1. In accordance with the invention; and

FIG. 6 is a flow chart of the analysis phase as shown in FIG. 1 in accordance with the invention.

### DESCRIPTION

Referring now to the drawings wherein the showings are only for purposes of illustrating a preferred version of the invention and not for purposes of limiting the same. The disclosure of U.S. Pat. No. 8,490,024 is hereby incorporated in its entirety. The disclosure of Michael H. Peters, CRACKING THE COLLABORATION CODE, NEMBY: The Anti-NIMBY Technology, (Architekton Resources, LLC 2016) is hereby incorporated by reference in its entirety.

Various embodiments will be described in detail with reference to the drawings, wherein like reference numerals represent similar steps throughout the several views. Reference to various embodiments does not limit the scope of the claims attached hereto. Additionally, any examples set forth in this specification are not intended to be limiting and merely set forth some of the many possible versions for the appended claims.

The present invention focuses on a multi-component method of real-time collaboration for the purpose of creating and negotiating a plan in order to carry out a project or change. The method emphasizes mitigating and overcoming barriers created by negative neurological hormones while facilitating the release of positive hormones. In particular, a method is provided which is designed to uniquely assist and encourage group collaboration within charrettes, group presentations, negotiations, and solicitations to government, community, investors, and teams, for the purpose of creating and overcoming irrational objections to a project (as discussed above commonly referred to, in virtually every industry, as “NIMBY”—“Not in my back yard”).

The method can be applied in any context relating to a proposed project or change requiring the agreement of many differently interested persons—encouraging efficient collaboration to bring about change or carry out the proposed project. For example, the method can be specifically utilized to assist during the planning process of real estate development amongst a community—bringing together disconnected and differently interested parties such as real estate developers, architects, community members, investors and politicians as to determining together the best use of a plot of land before and during development as well as determination of objective variables of the project. Real estate development is contingent upon the interested parties being in agreement and therefore there is a substantial need to provide a method of encouraging group analysis, planning and conclusion as a whole.

Again, it will be noted that the application of the inventive method can be applied to any area that requires collaboration and planning of a proposed change—such as planning business and corporate goals and changes, research and development projects, scientific and engineering projects, educational planning, and even planning the details of a vacation. Throughout the disclosure, real estate land planning will be utilized as the primary example of the ongoing project. However, it will be noted that the inventive methodology can be applied to numerous other scenarios for facilitating group collaboration by mitigating the release of negative neurological hormones and facilitating the release of positive neurological hormones.

The inventive method utilizes both tactile technology, and the science of neurology to secure necessary chemical assistance of oxytocin, dopamine, and serotonin, while subduing adrenaline, cortisol, and other destructive agents. The inventive method, utilized in conjunction with tactile technology influences, changes, and encourages positive thought patterns and outcomes, dramatically overcoming the NIMBY mindset amongst group collaborators. Experts at the University of Chicago and elsewhere, have estimated that the NIMBY mindset has harmed the GDP of the United States by a full 10%. Overall, this multi-component method of real-time collaboration psychological changes outcomes by negotiating and developing by mutual ownership of the project (rather than the automatic adversarial reaction) to achieve the proposed objective of invention or development or change.

NIMBY is the predictable psychological resistance to changing pretty much anything. NIMBY situations erupt with the call to change or improve any piece of property or project, or relationship, or habit. The NIMBY response is often an inexplicably irrational reaction, or even anger, when “ownership” or local “respect” are perceived to be threatened, particularly by an outsider or competitor. Invasion of space, regardless of the sometimes poor condition of that space, or the value of the promised improvements, creates the environment for a potentially hostile, often unreasonable “Not in MY Back Yard” response. This happens daily in the workplace, in communities, in families, and in every type of human undertaking, collaboration, or relationship.

NIMBY is like the proverbial “knee-jerk reaction” or patellar reflex. The lower leg “boings” up with the slight pop of a rubber mallet without any conscious thought by the patient. It just happens, if we're alive. NIMBY is kind of like that. If we're alive, it's in play.

When an outsider suggests “change” to anything, or “improve” to anything, or “different” to anything, NIMBY is likely to happen. The “the old is better” and “we've never done it that way” and “Not In MY Back Yard” are just knee-jerk reactions. People want control of their own lives and world, and understandably so. It's in our makeup to insist on freedom, and owning, and no one is going to take those away without a fight.

It may seem irrational, and may actually be irrational, to “prefer” the status quo and lack of progress, or even poverty and bad schools, to “change,” but it is “knee-jerk” and automatic by many.

NIMBY is nearly as “medical” and “physiological” as the patellar reflex. We would normally think that someone “hating on” a “great idea” is just a jerk. It wouldn't normally occur to us that resistance to change or an idea is often essentially a chemical version of the “knee-jerk.”

It seems crazy to be angry at a project or opportunity that could dramatically help one's life and family. NIMBY is indeed weird. But, would it help us navigate our path if we were aware that a NIMBY reaction is not automatically a declaration of war from a mortal enemy, who must be crushed or deceived into capitulation?

NIMBY, and intensely negative reactions in negotiations or proposals, are nearly always unintended CHEMICAL REACTIONS due to our unintended provocation, resulting in a hormone release or dump in our counterparts.

Therefore, we needn't allow NIMBY attacks to offend or frustrate us, or to easily defeat us. And, there's no need for retaliation, lying, or manipulation to conquer an enemy of progress or our awesome idea. There is a significantly more effective approach to presentation, negotiation, collaboration, crisis management, and relationship enhancement.

By way of background, here's how our bodies “work”: First, we all have DNA that affects our health, moods, inclinations, and preferences. As examples, to what extent we are drawn to caffeine is a genetic marker that can be tested from a saliva sample, as surely as your skin pigment, dimples, hairline, handedness, and tongue rolling talent may be discovered from having licked an envelope. “Williams Syndrome” is present at birth in about one in ten thousand children due to some missing genes in chromosome. This crew loves to talk to strangers and will often run off in a crowd to make new friends. Friendliness can be a genetic trait? And, guess what. So also genetic maps may create different tendencies and temptations in each of us, such as laziness, impatience, anger, fear, internet gambling propensity, stealing from a store, and millions of other normal abnormalities and abnormal normalities. DNA tendencies are amazing. Choices can still be made for, or against, all such things, but the diversity of DNA-related anti-social tendencies is almost shocking.

Second, science says we are also chemically and electrically hardwired by situations in our youth. Childhood hugs, loud noise, music, color, texture, drugs, diet, relationships, and our experiences “whether good or bad” can all actually hardwire neuropathways. This process often happens before we are even old enough to remember any events. Our circumstances or childhood crises create hardwired tendencies, social perspectives, and even character qualities “to embrace or to overcome. Our inclinations, characters, preferences, politics, and worldviews are deeply formed by “an absentee father and domineering mother” and tens of thousands of other possible environmental patterns or incidents. Our choice of responses to various stimuli, and our individualized pressures associated with those specific stimuli, are likely very different, scientifically. We should be aware of this fact if we hope to have something beyond statistically mediocre results in negotiations and life.

We are not just the product of rational adult thinking and decisions, politically, academically, or any other way. A book written by a retired Federal Judge pressed this point unambiguously. The judge never knew of another judge who made decisions based on the evidence of the case, alone. He claimed all judges' decisions can be predicted by what school they went to, who their friends are, and other cultural markers. After the judge makes their ruling, their clerks then write the judge's “opinion” statements and backfill with the precedents and laws to support the decisions. The judge's rulings are based on his “feelings” of social justice and his prejudices, not specifically law. In his observation of fellow justices, over thousands of cases and several decades on the bench, this Federal judge found the rare exceptions to this predisposition to oblige his educational and social environment . . . was when the media and public opinion became involved. DNA and Hardwiring do matter, even in the justice system. Public scrutiny and hormones may be the only means for accessing a fair trial. Hans Gieng's 1543 sculpture of the blindfolded Lady Justice takes on new meaning in neuroscience. Jurisprudence is truly blind, without even knowing it is so.

Even in the Supreme Court, 30% of the “opinions” are entirely written by clerks. We are all seriously affected by family, academic experiences, and feelings developed in and by our youth. The neural pathways are literally hardwired or they die off. This hardwiring then promotes within us certain biases and reactions we must embrace or overcome in our adult lives and relationships.

DNA, and experience-based neural coding and hardwiring are “historical” markers. DNA and our hardwiring influence our health, our preferences, and our characters. They definitely create some of the choices and decisions specific to our personalized and distinct human ecosystem, to embrace or to overcome.

Third, what about real-time influences of decisions or behavior or reactions? There are historical markers that influence us. There are also spontaneous and instinctive influencers we are all subject to, by design.

Humans are designed to be hormone factories. Our bodies discharge various emotion-causing chemicals into our veins and brains as circumstances occur around us. An adrenaline release or dump can impart superhuman strength sufficient to lift an automobile off of a cat, if one were so inclined. During public speaking, adrenaline and cortisol can relocate your stomach to your throat and exaggerate that undesired development with a quivering voice and complete brain freeze. Understand that to be a horror-moan dump in your walking chemistry kit called “human.” It happens to all humans.

So, now we can grasp this also, in that context: usually when a NIMBY-ite is resisting a great deal or awesome project, he is not just being a jerk. That irrational and hostile reaction is frequently just as involuntary as a “knee-jerk reaction,” or fear of public speaking. That's important to know.

The instantaneous hormone release that all humans have to different stimuli, whether evoking rage, insecurity, a yawn, or irresistibility and warm fuzzies, make us like Vending Machines, in a way. Each human has buttons that dispense hormones and chemicals. These chemicals are there to protect and encourage humans, and sometimes give us super-powers.

Here's why this matters: Flawless logic in our presentation or proposal will NOT overcome DNA, childhood hardwiring experiences, OR the real-time chemical-dispensing factories of humans. Scientifically, brain scans show that what humans think are frontal lobe “rational” decisions or “justifiable” responses . . . frequently are not so, at all. Our logical minds are often entirely blocked by our emotions. Humans don't even know this has happened.

If true for most humans that are mature and together, this hormonal phenomenon will also be true, obviously, for the stakeholders, the collaborators, the community, the voters, the terrorist, the financier, or children. Science and brain scans say none of us are as “logical” as we claim.

Since we know this is scientific reality, no matter how people think or “feel,” people can now begin to improve the outcome of relationships, and projects, and elections.

Most cells in the human body are generally 55-95% fluid. We are designed to be peanut butter batteries in the aforementioned 15-80 mV range, turning the food we eat and the liquids we drink into energy and communication between cells. We are 65% oxygen, 18% carbon, 10% hydrogen, and 3% nitrogen.

The other 4% of human composition includes essentially 0% of aluminum and silicon, which happen to be the number two and three most prevalent elements in the earth's crust. First ranked in the “primordial soup” of “earth” is 46% oxygen, then aluminum and silicon accounting for over 33%. “Mother Earth” didn't bequeath her DNA to humans.

So, what do we do with this information about the earth suit of humans? In operating an “electric drill” we assume some things. We know to avoid the sharp end, plug in the cord, and pull the trigger when drilling a hole. It's just how it works.

Humans are chemistry kits on two legs. Humans are millivolt and chemical hormone-based life forms. As we seek to build consensus and relationships, we need to function with some recognition of how we are all made. Like the electric drill, it's a “logical” conclusion that we should stay aware of the Hormone Vending Machine buttons. These “hormone dispensing buttons” change everything in our communication, our relationships, our collaborations, and our negotiations. To march valiantly onward with our agendas and projects, mindless of chemical reality, is to invite mediocrity at best, and possibly unnecessary disaster.

Our human design includes a set of DNA parameters. Our DNA functions as banks to the river of propensities for our health and our choices. Some of this DNA can be destructive, and some helpful to our goals and relationships. There are still choices and options, since no one is forced to sight-read piano concertos from the age of five, even if genetically capable within their DNA river banks. Likewise, no one is forced to have fits of rage as adults, simply because “my mom had red hair.”

Our design also includes “nurture” aspects that hardwire our “inclinations” and potential path. Again, there are options, but our “three brains” are chemically and electrically altered by hugs and noise, drugs and diet, and our childhood experiences.

Hormones ride piggyback on that DNA, and those hardwired predispositions, in ourselves and those we know. These hormones create real-time opportunities and obstacles, day to day, situation by situation.

We'll now discuss in detail the negative hormones. We will discuss these more than once, from different perspectives, since both induced and unintentional hormone release is the heart, so to speak, of this technology.

Norepinephrine, Cortisol, and Adrenaline are the three major stress hormones. Stress hormones increase blood flow to skeletal muscles, intensifies breathing and heart rate, dilates pupils, and elevates blood pressure. There are positive implications of these hormones in protecting and energizing humans. But as they relate to resolving “Not in MY Back Yard,” these are generally chemicals that will hinder the desired positive outcome. These hormones create resistance to resolving difficulties, closing sales, releasing hostages, and arriving at mutually productive conclusions, or building relationship bonds.

We will very briefly discuss what these three counter-productive hormones are, then move on to the positive and productivity-enhancing hormones. Then, we will discuss the practical means of minimizing the bad boys of negotiation and relationship, and of provoking the release of white hat hormones. Some hormones negative. Some hormones are positive.

Norepinephrine: When a person is stressed or in a state of perceived danger, the body produces a “fight-or-flight” hormone that is generally “badness” in our relationships and negotiations and presentations. Norepinephrine, released into the bloodstream by the adrenal glands, causes the body to have an increase in arousal and alertness, generally proving to be a distraction from deal-making. The “self-preservation” instinct kicks in, and consequently the capacity for empathy diminishes.

On the other hand, this hormone promotes vigilance, focuses attention and can even enhance memory retrieval. If you have stimulated this hormone your interaction or presentation will be long-remembered. In most cases, however, not remembered for the good, since “flight or fight” pulse-pounding, fist-clenching hormonally induced reactions are not usually deal-makers. The “memory” now hard-wired even if forgotten by short-term memory will simply create an obstacle to future deals, and future trust and relationship. Even others who look or sound like you, or offer a similar product or partnership as you are suggesting, will pay a future price for the norepinephrine you may have accidentally caused to be released in your partner.

Generally this is bad, and a hormone to “not” stimulate or incite. A surge in norepinephrine in a person will not subside for at least 30 minutes, and up to 24 hours. Psychologists are legally allowed to “hold” people who have had a meltdown for 72 hours to determine the underlying condition, since hormones can sometimes take that long to clear.

It's best to “take a break” rather than press on if there is a norepinephrine hormone dump in your partner. As described, the emotional hormones in the brain overrule the frontal cortex of the brain. If this happens, most “reason” and consideration of consequences, as well as decisions and memories about “good and bad” . . . just “disappear” temporarily. It is no wonder that wars, destroyed young lives, damaged marriages, and disastrous business deals are difficult to avert when this hormone dump is precipitated by something we have said or done. Rational thinking is not a big player or a big help during this hormone session.

Cortisol is commonly known as the “stress hormone” and is also produced within the adrenal gland. The entire human body is affected by this hormone when released. Olympic athletes know that lactic acid, poor oxygen uptake, poor REM sleep, and therefore poor performance are all byproducts of raised Cortisol levels. Wounds heal slowly, memory is adversely affected, fertility is harmed, muscle growth is diminished, and blood pressure rises. Nothing in this menu of side-effects from Cortisol helps build relationships, trust, comfort, or anti-NIMBY negotiations.

Our choices to navigate past events or words that could create a Cortisol dump greatly enhance our chances of success. When pursuing a promotion at work, or leading a child to make good choices regarding homework or friends, or presenting plans for a “new park and bridge” to investors, government, or community, do and say the things necessary to avoid cortisol release, and reduce cortisol that walked in the room before the meeting.

There are many triggers for Cortisol and other “debilitating” hormones that serve purposes of protection, rather than collaboration. Some of these triggers, such as drinking and smoking, lack of sleep, bad diet, tumors, as well as chemically or genetically induced depression are not within our influence, generally, except in the closest of relationships. However, there is a part we can play, strategically, in choices to reduce Cortisol and other negative hormones, as well as increase positive hormones.

Adrenaline (also known as epinephrine): During a stressful situation, again, the adrenal glands receive a message from the brain to shut down other systems in order to produce adrenaline. It is also a “fight-or-flight” hormone.

Adrenaline is known primarily for its resulting “surge of energy,” as well as for the 1 mg injection into the hearts of cardiac arrest victims. Adrenaline is seldom a friend in negotiation, or bonding. While it may be useful in an automobile accident, in a NIMBY environment an adrenaline dump is one of the last things you would desire amongst community members, or government representatives, or investors.

The primary instigators of adrenaline are surprise and fear. Subjects injected directly with adrenaline become far more negative and paranoid than the control group. Long term memory and reason are temporarily annihilated. A marker is placed that then causes the negative “feelings” of such an event to replay when anything reminiscent occurs in the future. This is important to understand, when there is no other known rational explanation for a participant's reaction. They may be experiencing an adrenaline flight or fight release due to previous bad experiences, or deadline-related stress, physical threat, noise, bright lights, or high ambient temperatures.

We will discuss methods of avoidance of these hormones further, now that we have identified these negative hormones.

Dopamine, Oxytocin, Serotonin, Endorphins, and Anandamide are the major hormones associated with success, contentment, pleasure, and bonding. The brain and glands are very “stingy” in releasing these strong drugs, since the reward system would not be functional or effective if “rewards” were granted arbitrarily or continually.

Dopamine: Finding its home primarily in the midbrain, it assists blood flow and coordination, and is released as a “reward” for achieving a goal. There is a sense of accomplishment, and pleasure is stirred upon a dopamine discharge. Dopamine reinforces motivation, arousal, and reinforces behavior accordingly. Excessive levels of dopamine can suspend rational behavior somewhat, in order to secure affirmation or accomplishment. Low levels of dopamine tend to result in lack of enthusiasm, self-doubt and procrastination, serious opponents to good relationships and good deals. On the extreme end, Parkinson's Disease is associated with a lack of dopamine.

Oxytocin is the “bonding” or “cuddle” hormone. Oxytocin is produced in the posterior pituitary. It is essential in social bonding, and as a natural bonding enhancement for married couples during and after sexual activity (present in both genders), as well as bonding with spouse and babies during and after childbirth. Laughter also releases oxytocin, as does giving a gift, and giving or receiving a hug and simple touches. Childhood development and social skills are damaged by the lack of oxytocin in the formative years.

Oxytocin brings feelings of contentment, diminishes anxiety, and fortifies an event or circumstance with calmness, trust, and security. This is a positive hormone. It is proven that oxytocin literally assists in the healing of wounds. Laughter and love “are the best medicine” as the saying goes.

Serotonin acts as a neurotransmitter, a type of chemical that helps relay signals from one area of the brain to another. It is manufactured in the brain by one of the ingredients of Thanksgiving turkey, and resides primarily in the blood, central nervous system, and intestinal tract once formed. Serotonin plays a major part in mood, anxiety relief, happiness, and calmness. Low serotonin levels can result in loneliness or depression. Sunshine and doing things for others who express gratitude assist favorable serotonin dumps.

There are at least twenty different endorphins that can be released in the human body. Endorphins are sometimes referred to as the “rock star” hormone, since they can create a sense of euphoria and invulnerability. Endorphins, a natural cousin of morphine and opiates using the same neural connections are the human body's way of responding to fear, pain and stress. Vigorous exercise, laughter, sexual relationship, aromas, chocolate, locking your doors, childbirth, obsessive behaviors, food, and other triggers can invoke the release of endorphins. Individuals can be triggered differently based upon the previously discussed DNA and formative experience hardwiring. Excessive endorphin access for personal “highs” will result in anxiety, depression, edginess and flight or fight, even in meaningless events. Less is more.

This hormone, if introduced in the collaboration event or negotiation can be useful, or if mistimed it can be a barrier to empathy, thoughtful manners, and dialog.

Anandamide was recently discovered and is defined as the “bliss” hormone and is experienced in the earliest stages of pregnancy, and ovulation. It is also referred to as “the first communication between mother and child.” Anandamide is sometimes associated with joy, calmness, and dark chocolate. It plays a role in alleviating depression, relieving cortisol stress, prompts some short-term memory failure (speculated as a design to cause new mothers to forget birth pain), and increases appetite. It is manufactured in the higher brain centers and breaks down quickly in the body, making its effects short-lived. The risk of lack of decisiveness, and the effect on short-term memory, are not overly conducive to most negotiating situations, however.

Now considering again, the “Not In MY Back Yard” phenomenon, but this time through the lens of brain chemistry.

The NIMBY type attitude happens. It happens often. In a major proposal or negotiation, there will nearly always be a person who simply will not be convinced based on the merits, logic, or benefits of the project. The opponents will surface, whether through misunderstanding, competitive pride, fear or sentimentality, or by a strategic alliance with a competitor, or just to be noticed.

Sometimes the person having the NIMBY type attitude will show a smile and nod, and then destructively backchannel with media, or decision-makers, or politicians. The opponent may convulse in a public tirade. Are they craving attention, or sincerely angry at injustice this “change” will impose upon him or her? Either way, with proposals of substantial change there are likely to be opponents bent on defeating the idea or development, claiming “the old is better, the old is better” and “we've never done it that way before.”

To illustrate the essence of NIMBY, a neighborhood in Washington, D.C., once known as Cappers instead of Capitol Quarters, was created out of bulldozed rubble a few years ago.

A thoughtful quote from one of the generational NIMBY residents who had opposed the change, in spite of the area's legendary murders, mayhem, and poverty: “People develop a sense of community and place where they are . . . there is a terrible sense of loss for what the community was: we raised our children there, you ate, you drank, you broke up with boyfriends. And now it is totally gone—there are no remnants of who we were and what we were as a community.”

I think we can see that the NIMBY problem in negotiations and collaborations must be respected. Even when someone is defending the indefensible, such as staggering and dangerous daily crime in a neighborhood, there is something “emotional” and hormonal blocking the rational. What is the way forward, when emotions, fear, memories, and stories rule, though “change” for the greater good is the logical path?

Let's apply what we know about humans and their millivolt chemistry earth-suits. Let's lay out a means of mitigating those “Not in MY Back Yard” responses when they are truly not helpful. Let's choose paths that address the chemical obstacles alienating the opposition's frontal lobe with “flight or fight” instead of collaboration. Let's access the helpful hormones and soften the shouts of the blinding hormones. Then we can discuss the opportunities. Just as in Flatlands, we can address the dominant realm, the superior dimension, to accomplish the greater good.

What do we need to do, then? The Preliminaries, the Proposal, and the Project are all distinct and essential stages of a Negotiation, Collaboration, Project or Development that require the participation or approval of Community, Government, Business Partners, or Investment.

In each stage “people” are involved. Therefore, in each stage there must be decisions and actions that recognize the Flatlands Phenomenon, the nature of humans to unknowingly and predictably allow Emotional Brain Chemistry to triumph over Logic. This reality must be considered and acted upon carefully. And when we appreciate this reality, we are no longer at a disadvantage or easily surprised, or hurt. Instead, we hold a competitive advantage over all of those who would position themselves as foes, or NIMBY-ites, or business rivals.

Certainly, whatever people choose intentionally to do in the Preliminaries, the Proposal, and the Project must necessarily avoid provoking the NIMBY badness hormones of Norepinephrine, Cortisol, and Adrenaline. It is unlikely that the introduction of these hormones could cause anything but harm to productivity. Understand this: carelessness, ego, and lack of preparation for NIMBY and Chemical “reactions” from the amygdala obliterate and unnecessarily blow up deals and relationships. Why? The loss of frontal lobe reason and consideration of consequences is blinding.

There is no possible way to quantify the total damage to GDP annually of unnecessary provocation of badness hormones. Poor corporate value creation, inept recruiting and retention, billions of dollars in wasted training of replacement employees, geographic relocation of employees, poor work ethic, and lack of focused productivity may all be hormonally addressed. If humans are involved in any way, value creation and retention are affected by hormone creation and retention. It's senseless and naïve to not address this truth in practical ways.

Perhaps the true NIMBY GDP loss, when internals are included, is 20% of the world's productivity and $20 Trillion per year. Would we believe this lack of efficiency, primarily due to carelessness, would justify some education and systematic process to calm the chemical factory of the earth-suits with which we collaborate? Compare this to the cost of war on the globe in 2015, estimated at $13.6 Trillion by the 2016 Global Peace Index.

To tweak the hormone factory by thoughtful concern helps the world to be a better place, rather than a bitter place. Better living through chemistry. Better management of our human chemistry.

Life is a non-stop negotiation. Every relationship, every interaction, every advancement is a negotiation, a collaboration, a charrette in some sense. Every interaction of our lives engages in some way the chemical factory of others, and the outcome of their adventure, and our own.

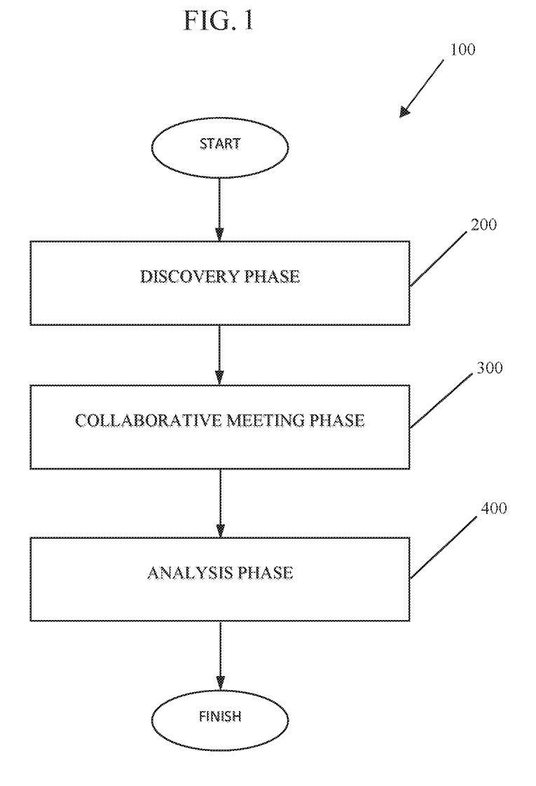

With that said, the current application proposes a unique multi-component method to address the above-mentioned issues. Now referring to FIG. 1 and as designated by numeral 100, the multi-component method of real-time collaboration may comprise three primary phases. In the version, the first phase is a discovery phase 200 for identifying a proposed project or change, identifying parties involved, communicating with parties, and inviting them to collaborate and discuss details of the project of change. Next, there is a collaborative meeting phase 300 which is the core of the inventive method. The collaborative phase 300 generally comprises a meeting of all interested parties, providing a visual graphical canvas, providing a palette of visual graphical variables, and commencing party collaboration resulting in a project plan which all parties agree upon. Finally, an analysis phase 400 is introduced in order to analyze the financial feasibility of the proposed project plan and provide a follow up meeting of all parties to summarize the conclusion of the feasibility of the agreed upon variable of the proposed plan.

As discussed above, the multi-component method utilizes both tactile technology and a unique methodology in order to promote a change in attitude shift from the NIMBY mindset to a mutual ownership attitude regarding agreement as to the project and associated variables. In particular, the invention utilizes a user interface or visual display which provides both a visual graphical canvas and a palette of potential project variables which can be graphically selected and chosen via drag-and-drop or other selection protocol onto the visual graphical canvas. This provides the parties a potential visual graphical solution and to illustrate consequences of chosen variables.

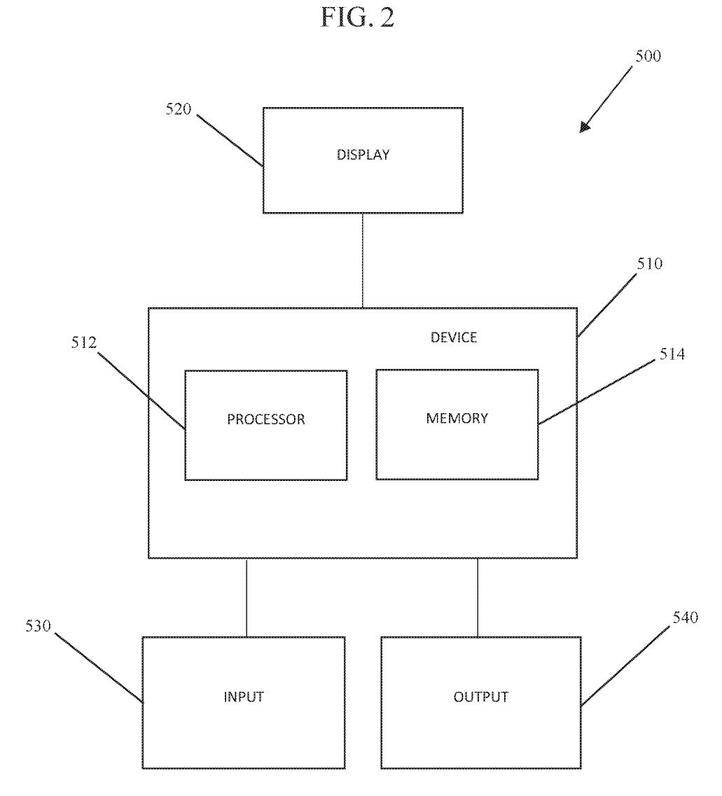

FIG. 2 is a block diagram illustrating an example computer system 500 including a device capable of providing the visual graphical canvas and palette of potential project variables on an electronic display. In the illustrated example, a processing apparatus or computer 510 is provided in order to generate the user interface on a display 520. The computer 510 comprises a processor 512 and a computer readable medium 514 for storing computer instructions, which when executed by the processor 512 causes the processor 512 to generate a user interface on the display screen 520. In a version, device 510 is a personal computer. Other versions include hand held computers, smart phone devices, touch screen tablets, laptop computers, or any other device having a processor and able to access instructions in memory.

In the illustrated version, device 510 is connected to a display 520. Display 520 is preferably, for example, a projection monitor or other large electronic visual display. Other versions include a television screen, computer monitor or any other device capable of displaying a user interface having a visual graphical canvas and a palette of potential project variables. Device 510 is also illustrated as connected to an input device 530 and output device 540. Examples of input device 530 include a keyboard, mouse, touch pad, touch screen, track ball, voice recognition system, even touch screen technology, or any other device capable of receiving an input from a user. Examples of output device 540 include display 520, a printer, plotter, copying machine, or any other device capable generating a hard copy of project proposals and variables. In another version, output device 540 is a storage medium or digital communications device. For example, output device 540 is a flash drive onto which a plan can be stored. In another example, output device 540 is a network-connection modem that transmits project data across a network such as the Internet, a local-area network, a wireless network or any other digital communicating system as known in the art.

Memory 514 is computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, BC-ROM, digital versatile disks (DVD) or other optical storage, magnetic cassettes, magnetic tape, magnetic disk storage or other magnetic storage devices, or any other medium which can be used to store the desired information and which can be accessed by the processor 512. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Combinations of any of the above should also be included within the scope of computer readable media.

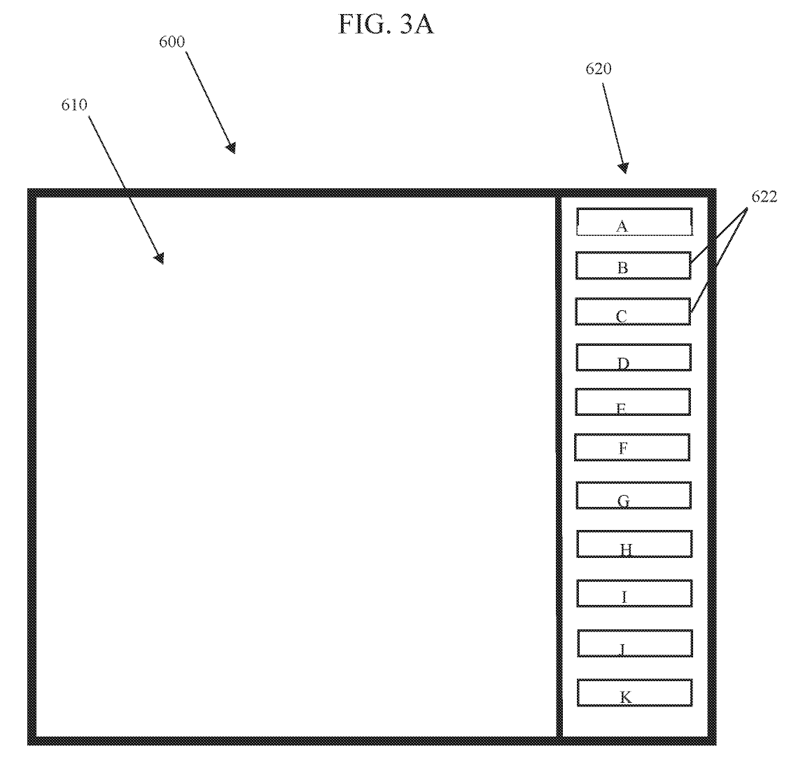

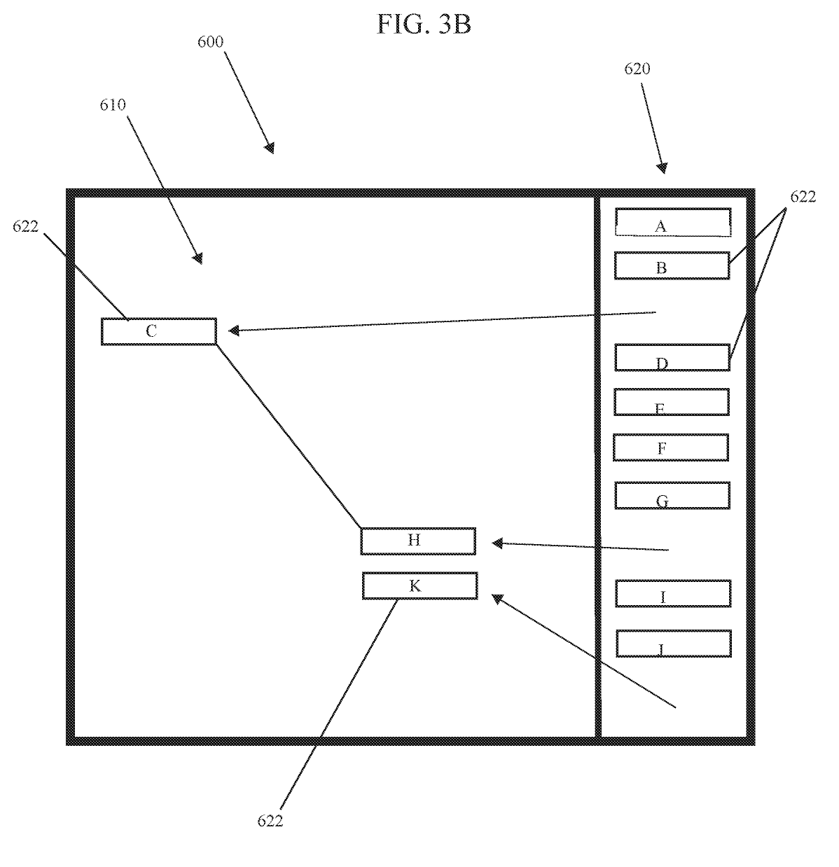

FIG. 3A and FIG. 3B are screenshots of an example user interface 600 which provides both the visual graphical canvas 610 and the palette 620 of potential project variables 622 which can be graphically selected and chosen via drag-and-drop (FIG. 3B) onto the visual graphical canvas 610 in order to provide the group viewers a potential visual graphical solution and consequences of said variables for which a project plan can be developed and displayed which will be described in more detail below.

In further detail and as illustrated in the version, the visual graphical canvas 610 essentially provides a visual space where proposed project variables 622 can be graphically selected and displayed independently or in combination in order to visually display a proposed unique project solution. The project variables 622 are chosen from a palette 620 of potential project variables 622 which can be found in a sidebar (FIG. 3A and FIG. 3B, A-K) which is visually separate and apart from the visual graphical canvas. In the illustrated version, the palette sidebar 620 is positioned adjacent and to the right of the visual graphical canvas 610.

Other arrangement of the visual graphical canvas 610 and palette 620 can certainly be envisioned. In some versions, the palette sidebar 620 may be selectively rearranged or located in alternate locations within the user interface and relative to the visual graphical canvas 610. In another version, the palette side bar 620 is a floating window that can be separately located apart from the visual graphical canvas 610.

The palette side bar 620 may include any variable that could logically or even illogically affect the project plan objectives. For example, relating to the real estate development proposed project, variables may include among many others such as projected project costs, building construction location, proposed building structure attributes, building permit variables, traffic implications, environmental and economic implications, etc. The user interface may also include additional tools and options such as tool boxes, info boxes, guide windows and other user interface options and attributes as known in the art. For example, an info box is a display window that displays information pertaining to the current project details such as background and information related to the real estate development proposed project.

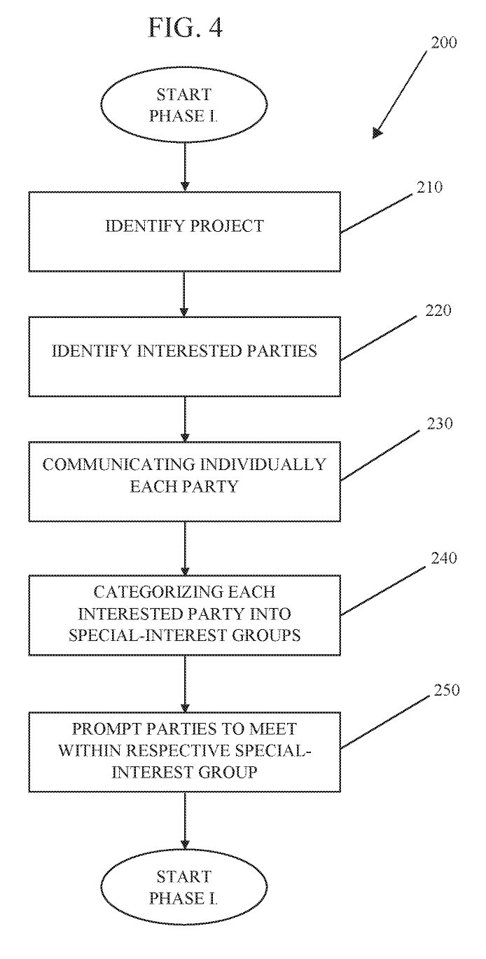

Now referring to the flow chart illustrated in FIG. 4, the discovery phase 200 of the inventive method will be discussed in detail. Generally, the purpose of the discovery phase 200 is to identify a proposed project or a proposed change and identify the parties that may be affected by the project or proposed change or have an interest in some form therein.

In the illustrated version, the first step 210 in the discovery phase 200 is to identify a project which will bring about change and affect a plurality of differently interested people and/or organizations. The project can be any project that proposes a change which will affect multiple parties with differing view and differing interests—requiring some level of collaboration and agreement amongst the interested parties in order for the project to move forward. For example, the development of real estate inherently proposes significant changes that will affect differently interested parties. Changes such as geographical and physical attributes to the developed real estate and surrounding properties, local economic impacts as well as a change in surrounding property values, environmental impact, and logistics regarding local infrastructure.

The next step 220 in the method is identifying parties that may be affected by the project and the resulting change. Per our real estate development example, interested parties may include real estate developers, architects, civil engineers, community leaders, investors, financiers, politicians, local law enforcement, neighboring property owners, nearby business owners, and the community in general among others. Thus, there is an importance in regard to identifying all parties that may be affected by the project and thus should be part of the collaborative equation and, most importantly have an ownership role in determining the project variables and outcome. In particular, real estate development hinges on collaboration and agreement amongst the affected parties.

Once the interested parties are identified in step 220, the next step 230 in the process is—communicating individually to each interested party distilling how they may be affected by the proposed project, introducing proposals and details of the project, and creating an overall interest in further collaborating about the project. In particular, the project leader or other person of authority explores each interested/affected person—asking them questions and creating a dialogue about the project and how it may affect them. The person of authority may even find it effective to go door to door—directly meeting each interested party. Otherwise, setting up meetings to isolate each individual in order to find out what their initial opinion is on the project, where they stand, and best educate one another about the project and project implications. The questions asked should be tailored to obtain information—asking questions regarding whether the individual person is currently satisfied or dissatisfied with the current situation and ultimately find out what their personal desires and concerns are. Moreover, the dialogue should create a “buy-in” or interest from the perspective of the interested individual—encouraging them to provide their opinion, influence and analysis of the proposed project flushing out issues. All of this information is gathered and documented. From this information, each party can be categorized into distinct special-interest groups according to their individual concerns and desires as well as how the project will potentially affect them (Step 240). As in the real estate development example, neighbors adjacent to the proposed project development site may have contrasting views with parties that stand to obtain a monetary gain from the project, such as investor or the real estate developer or local businesses that may see an increase in sales due to a result of more traffic/people in the area.

In step 250, each party is invited and prompted to meet within special-interest groups in order to collaborate about the project and how it may affect their interests, concerns, and desires. For example, surrounding property owners that may be affected by the development of property are invited to meet in order to discuss how they may be affected as a group. Within the group meeting, special interest members are encouraged to collaborate, express their views, and draw conclusions as to how the proposed project will impact their world.

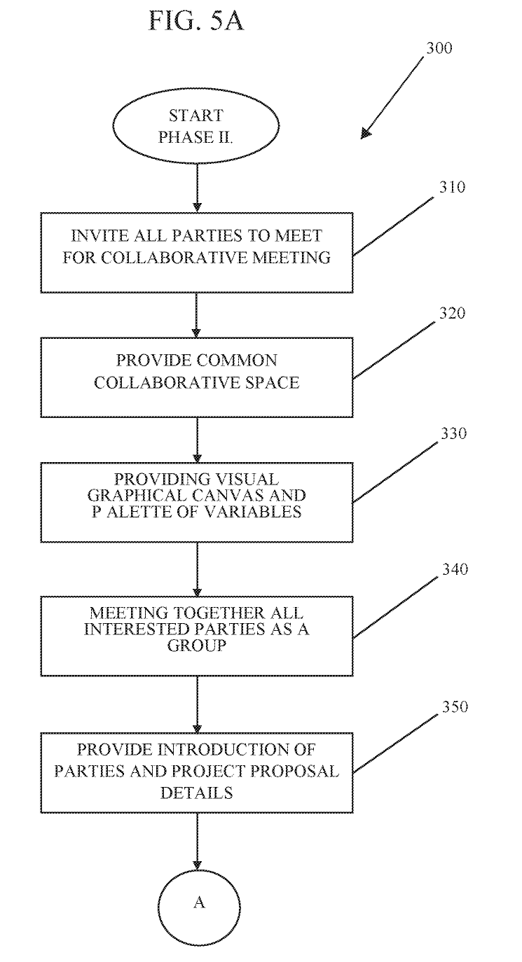

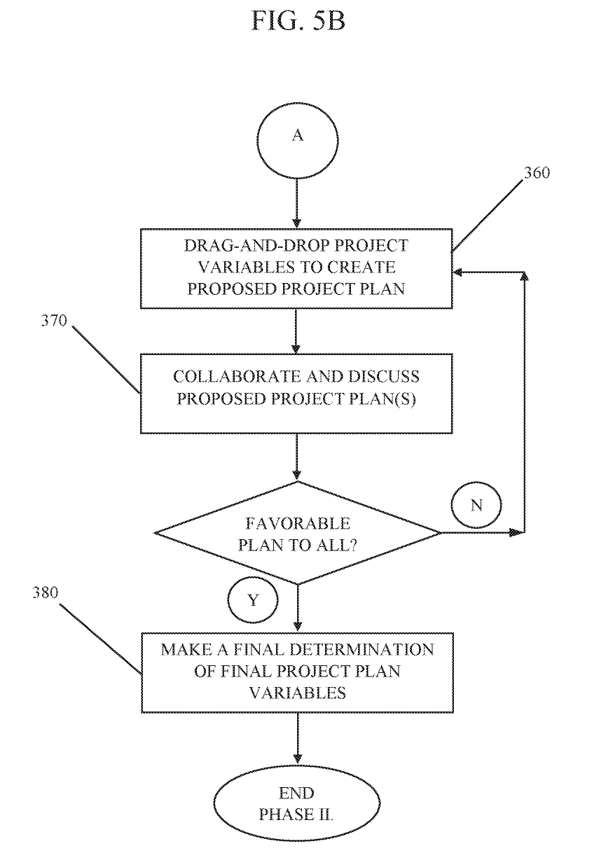

After all of the information can be obtained regarding the interested parties and special-interest groups, the collaborative meeting phase 300 is initiated by project leaders. FIG. 5A-5B illustrate an example flow chart of the collaborative meeting phase 300. The collaborative meeting phase 300 generally comprises a meeting of all interested parties, providing a visual graphical canvas, providing a palette of visual graphical variables, and commencing party collaboration resulting in a project plan which all parties agree upon.

In more detail, in step 310 all parties and special-interest groups are invited to a first collaborative meeting at a common collaborative space in order to collaborate and discuss details about the proposed project in order to formulate a plan moving forward. In step 320, project leaders ascertain and provide a common collaborative space for the meeting that is favorable for discussion and encourages collaborative thought. For example, the meeting space should have ample room that is well lit with comfortable seating as well as bright, clear acoustics so that all parties can properly hear the discussion and provide feedback. Refreshments and other offerings may be provided. Preferably, the meeting space is an auditorium, college lecture hall, or other space that is tailored for group presentations.

In step 330, at the common collaborative space, a computer or other apparatus 510 for displaying 520 a user interface is provided as described above. The user interface provides a visual graphical canvas 610 and a palette 620 of potential project variables 622 which can be graphically selected and chosen via drag-and-drop on the visual graphical canvas 610 in order to provide the parties a potential visual graphical solution showing the consequences of the selected variables 622. The user interface is displayed so that all members can adequately see the visual graphical canvas 610 and selectable potential project variables 622. Ideally, the visual graphical canvas 610 is displayed on a projection screen or big screen television in order for all participating members to see, hear, and provide feedback based on the selected project variables 622 seen on the display 520.

In step 340, all parties including all special-interest groups meeting at the predetermined common collaborative space at the designated time. Once all of the party members are at the meeting and the tactile technology 500 including the visual graphical canvas 610 and palette of potential project variables 622 has been properly setup, in step 350 the project leader provides a welcoming introduction and provides an overview of objectives of the project. Moreover, all of the members are adequately introduced and a brief meet and greet takes place. Specifically, and importantly, the project leader informs all members that “together the parties will start with a blank canvas and as a whole make an objective decision about the project variables that will benefit the entire group” in order accomplish and adopt an overall project plan. The importance of the introduction is to encourage the group to realize they own the entire project as a group, not simply owned by a real-estate developer.

Next, in step 360, the project leader with all parties of the meeting join together to drag-and-drop—via input from the project leader and in real-time—proposed project variables 622 onto the visual graphical canvas 610 in order to visually and graphically show a proposed project scenario comprising a unique arrangements of project variables in order for the group to collaborate and determine what arrangement of variables or solution is beneficial to the group as a whole (Step 370). Throughout the process, the project leader facilitates positive discussion and collaboration about each proposal or variable—asking “how does everyone feel about this combination?” “Is there anything that any interested party does not want to do?” This encourages the differently interested parties to come together to arrive at a favorable solution, together. For example, under the real estate development context, interested parties such as property owners, local business owners, financiers, all of whom have different opinions and views financially or even emotionally, are encouraged to provide input and analysis from their standpoint within the larger collaborative group setting. The group continues to propose different scenarios and project plans by drag-and-drop of optional variables 622 from the palette of potential project variables 620, discussing each proposed scenario until the group can arrive at a solution or plan 380 that is beneficial and favorable to the group as a whole. In other words, the group as a whole collaborate and discuss each proposed project scenario as visually displayed by the user interface in order to determine if the project scenario is favorable to the group as a whole. If the proposed project plan is not agreed upon, the parties continue to select alternative arrangements of the project variables providing unique proposed project plans until the group finds a solution that is favorable to the group as whole.

It will be emphasized that an important and unique element of the invention is the undertaking of providing a drag-and-drop real-time variable 622 selection from the palette of proposed project variables 620 and visually—as a group—placing them on the visual graphical canvas. This setting allows all members to participate in a physical capacity—creating a sense of ownership of the project by all members participating, rather than individuals feeling alienated, non-influential spectators, thereby maximizing positive neurological hormone release and mitigating negative hormone release throughout the entire process. The real-time selection process visually presented to the group in conjunction with the collaborative effort of the group emphasizes finding a group solution in an efficient way. In contrast and in the prior art teachings, typical collaborative meetings propose already set variables that are only considered previously by one of the many interested groups or group members. Thus, other interested members do not have the opportunity to select variables and voice their views as to selection of variables within a scenario proposed at the meeting. In the context of real estate, typical project proposals are created by real estate developers and then presented via community meetings in order to discuss the details thereof. Many of the variables have already been selected at this point, leaving out the input of many other interested parties in the community. Thus, these community members such as neighbors and local business owners and even politicians, encompass the “NIMBY” type attitude towards the real estate development as proposed—limiting and hindering the project from efficiently moving forward, sometimes wrapped up in this stage for years until a solution is finally pushed through, even forced through the “NIMBY” attitudes found in the neighborhood.

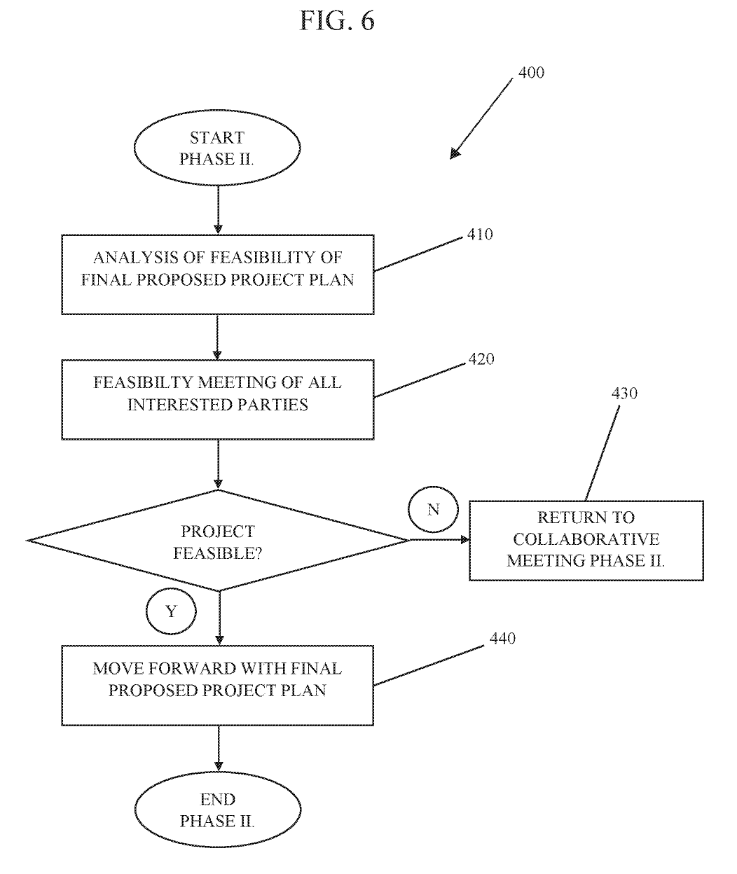

Now referring to flow chart illustrated in FIG. 6, the analysis phase 400 in the process will be discussed in detail. The analysis phase 400 is optionally introduced in order to analyze the financial feasibility and logistics of the proposed project plan 380 that was agreed on by the group and provide a follow up meeting to summarize and confirm the conclusion of the feasibility and analysis of the proposed project plan 380.

In the illustrated version, the first step 410 of the analysis phase 400 is to review and analyze the proposed project plan 380 regarding the feasibility and logistics of the chosen project plan variables. If it is determined that the project plan as proposed is feasible financially and logistically, a second meeting of all parties is organized per above as illustrated in step 420. At the second meeting, a presentation of the financial feasibility and logistics of the proposed plan is summarized and presented to the group. Otherwise, if it is determined that the logistics or financial feasibility of the proposed project plan is problematic, then the group is invited to rejoin efforts and initiate a second collaborative meeting phase 300. The process is carried out until a proposed plan is agreed upon by the group as a whole 300, analyzed and approved by the group in the analysis phase 400. In step 440, once a final proposed project plan has been approved, the project moves forward as planned as known in the particular industry or situation.

It shall be known that all the advantageous features and/or advantages do not need to be incorporated into every version of the invention.

Although preferred versions of the invention have been described in considerable detail, other versions of the invention are possible.

All the features disclosed in this specification (including and accompanying claims, abstract, and drawings) may be replaced by alternative features serving the same, equivalent or similar purpose unless expressly stated otherwise. Thus, unless stated otherwise, each feature disclosed is one example only of a generic series of equivalent or similar features.

What is claimed:

1. A multi-component method of real-time collaboration for the purpose of creating and negotiating a common objective plan by mitigating and overcoming barriers created by negative neurological hormones while facilitating the release of positive hormones throughout each phase, comprising:
(a) collaborative meeting phase, comprising the steps of:
i. identifying a project which will bring about change and affect a plurality of different interested parties and/or organizations;
ii. identifying interested parties that may be affected by the project and resulting change;
iii. inviting all interested parties to meet together at a first collaborative meeting in order to collaborate and discuss details about the proposed project;
iv. providing a common collaborative space for meeting that is favorable for discussion;
v. meeting together as a group all interested parties and special-interest groups at the common collaborative space;
vi. providing at the common collaborative space, an apparatus for displaying a user interface, the apparatus comprising a processor, and a computer storage medium storing program instructions, which when executed by the processor cause the processor to generate a user interface, the user interface comprising:
a. a visual graphical canvas; and
b. a palette of potential project variables which can be graphically selected and chosen via drag-and-drop from the palette to the visual graphical canvas in order to provide the parties a potential visual graphical solution and implications of said variables;
vii. providing an introduction of all interested parties and special-interest groups and objectives of the project, informing all interested parties that together the parties will start with a blank canvas and as a whole make objective decisions about the project variables that will benefit the entire group in order to accomplish and adopt an overall common project plan, thereby allowing the group as a whole to take ownership of the project, participate, and cooperate facilitating the release of positive neurological hormones;
viii. selecting by drag-and-drop one or more proposed project variables onto the visual graphical canvas in order to visually and graphically show one or more proposed project plans, each comprising a unique arrangements of project variables;
ix. collaborating and discussing as a group each of the proposed project plans as visually displayed by the user interface in order for the group to collaborate and discuss which project plan is most beneficial to the group as a whole; and
x. making a final determination of a final project plan as decided by the group as whole, if a final determination of a final project plan cannot be decided by the group as a whole, the process returns to the step of selecting drag-and-drop one or more proposed project variables on to the visual graphical canvas in order to visually and graphically show one or more proposed project plans until a final determination of a final project plan is made.

2. The multi-component method of claim 1, further comprising the steps of a discovery phase preceding the collaborative meeting phase, the discovery phase comprising the steps of:
i. identifying a project which will bring about change and affect a plurality of different interested parties and/or organizations;
ii. identifying interested parties that may be affected by the project and resulting change;
iii. communicating individually to each interested party distilling how they may be affected by the proposed project, introducing proposals of the project, and creating an overall interest in further collaborating about the project;
iv. categorizing each interested party into a distinct special-interest group; and
v. inviting interested parties to meet within each of their special-interest groups in order to collaborate about the project and how it may affect their interests.

3. The multi-component method of claim 2, further comprising the steps of an analysis phase following the collaborative meeting phase, the analysis phase comprising the steps of:
i. analyzing the feasibility of the final proposed project plan;
ii. meeting of all interested parties in order to present and summarize the conclusion of the feasibility analysis; and
iii. if the proposed project plan is determined as not feasible, the process returns to the collaborative meeting phase until a feasibly proposed project plan is obtained.

4. A multi-component method of real-time collaboration for the purpose of creating and negotiating a common objective plan, by mitigating and overcoming barriers created by negative neurological hormones while facilitating the release of positive hormones throughout each phase, comprising:
(a) a discovery phase comprising the steps of:
i. identifying a project which will bring about change and affect a plurality of different interested parties and/or organizations;
ii. identifying interested parties that may be affected by the project and resulting change;
iii. communicating individually to each interested party distilling how they may be affected by the proposed project, introducing proposals of the project, and creating an overall interest in further collaborating about the project;
iv. categorizing each interested party into a distinct special-interest group; and
v. inviting interested parties to meet within each of their special-interest groups in order to collaborate about the project and how it may affect their interests; and
(b) a collaborative meeting phase, comprising the steps of:
i. inviting all interested parties and special-interest groups to meet together at a first collaborative meeting in order to collaborate and discuss details about the proposed project;
ii. providing a common collaborative space for meeting that is favorable for discussion;
iii. meeting together as a group all interested parties and special-interest groups at the common collaborative space;
iv. providing at the common collaborative space, an apparatus for displaying a user interface, the apparatus comprising a processor, and a computer storage medium storing program instructions, which when executed by the processor cause the processor to generate a user interface, the user interface comprising:
a. a visual graphical canvas; and
b. a palette of potential project variables which can be graphically selected and chosen via drag-and-drop from the palette to the visual graphical canvas in order to provide the parties a potential visual graphical solution and implications of said variables;
v. providing an introduction of all interested parties and special-interest groups and objectives of the project, informing all interested parties that together the parties will start with a blank canvas and as a whole make objective decisions about the project variables that will benefit the entire group in order to accomplish and adopt an overall common project plan, thereby allowing the group as a whole to take ownership of the project, participate, and cooperate facilitating the release of positive neurological hormones;
vi. selecting by drag-and-drop one or more proposed project variables onto the visual graphical canvas in order to visually and graphically show one or more proposed project plans, each comprising a unique arrangements of project variables;
vii. collaborating and discussing as a group each of the proposed project plans as visually displayed by the user interface in order for the group to collaborate and discuss which project plan is most beneficial to the group as a whole; and
viii. making a final determination of a final project plan as decided by the group as whole, if a final determination of a final project plan cannot be decided by the group as a whole, the process returns to the step of selecting drag-and-drop one or more proposed project variables on to the visual graphical canvas in order to visually and graphically show one or more proposed project plans until a final determination of a final project plan is made.

5. The multi-component method of claim 4, further comprising the steps of an analysis phase following the collaborative meeting phase, the analysis phase comprising the steps of:
i. analyzing the feasibility of the final proposed project plan;
ii. meeting of all interested parties in order to present and summarize the conclusion of the feasibility analysis; and
iii. if the proposed project plan is determined as not feasible, the process returns to the collaborative meeting phase until a feasibly proposed project plan is obtained.

6. A multi-component method of real-time collaboration for the purpose of creating and negotiating a common objective plan by mitigating and overcoming barriers created by negative neurological hormones while facilitating the release of positive hormones throughout each phase, comprising:
(a) a discovery phase comprising the steps of:
i. identifying a project which will bring about change and affect a plurality of different interested parties and/or organizations;
ii. identifying interested parties that may be affected by the project and resulting change;
iii. communicating individually to each interested party distilling how they may be affected by the proposed project, introducing proposals of the project, and creating an overall interest in further collaborating about the project;
iv. categorizing each interested party into a distinct special-interest group; and
v. inviting interested parties to meet within each of their special-interest groups in order to collaborate about the project and how it may affect their interests; and
(b) a collaborative meeting phase, comprising the steps of:
i. inviting all interested parties and special-interest groups to meet together at a first collaborative meeting in order to collaborate and discuss details about the proposed project;
ii. providing a common collaborative space for meeting that is favorable for discussion;
iii. meeting together as a group all interested parties and special-interest groups at the common collaborative space;
iv. providing at the common collaborative space, an apparatus for displaying a user interface, the apparatus comprising a processor, and a computer storage medium storing program instructions, which when executed by the processor cause the processor to generate a user interface, the user interface comprising:
a. a visual graphical canvas; and
b. a palette of potential project variables which can be graphically selected and chosen via drag-and-drop from the palette to the visual graphical canvas in order to provide the parties a potential visual graphical solution and implications of said variables;
v. providing an introduction of all interested parties and special-interest groups and objectives of the project, informing all interested parties that together the parties will start with a blank canvas and as a whole make objective decisions about the project variables that will benefit the entire group in order to accomplish and adopt an overall common project plan, thereby allowing the group as a whole to take ownership of the project, participate, and cooperate facilitating the release of positive neurological hormones;
vi. selecting by drag-and-drop one or more proposed project variables onto the visual graphical canvas in order to visually and graphically show one or more proposed project plans, each comprising a unique arrangements of project variables;
vii. collaborating and discussing as a group each of the proposed project plans as visually displayed by the user interface in order for the group to collaborate and discuss which project plan is most beneficial to the group as a whole; and
viii. making a final determination of a final project plan as decided by the group as whole, if a final determination of a final project plan cannot be decided by the group as a whole, the process returns to the step of selecting drag-and-drop one or more proposed project variables on to the visual graphical canvas in order to visually and graphically show one or more proposed project plans until a final determination of a final project plan is made; and
(c) an analysis phase, comprising the steps of:
i. analyzing the feasibility of the final proposed project plan;
ii. meeting of all interested parties in order to present and summarize the conclusion of the feasibility analysis; and
iii. if the proposed project plan is determined as not feasible, the process returns to the collaborative meeting phase until a feasibly proposed project plan is obtained.
